(19) United States
(12) Patent Application Publication
(10) Pub. No.: US 2003/0031291 A1
(43) Pub. Date: Feb. 13, 2003

(54) X-ray apparatus

(76) Inventors: Yoshimichi Yamamoto, Chiba-shi (JP); Tsutomu Suzuki, Abiko-shi (JP); Hiroshi Takagi, Kashiwa (JP); Takashi Ishikawa, Nagareyama (JP); Kenzo Sawaide, Matsudo-shi (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/203,404

(22) PCT Filed: Apr. 17, 2001
(86) PCT No.: PCT/JP01/03290

(30) Foreign Application Priority Data
Apr. 18, 2000 (JP) 2000-116350

(51) Int. Cl. G21K 4/00

(52) U.S. Cl. 378/41

(57) ABSTRACT

An X-ray apparatus comprises a radiographic system for rotating an X-ray source and an X-ray detector across an object, and a table device for turning an object horizontally on the axis of X-ray irradiation perpendicular to the floor on which the radiographic system is installed. The X-ray apparatus is used to image an object at the optional angle to the longitudinal axis of the object.

### TECHNICAL FIELD

The present invention relates to an X-ray apparatus, and more particularly to effective techniques applicable to an X-ray apparatus suitable for a diagnosis method called IVR (Interventional Radiology, fluoroscopic catheter surgery) using an angiographic inspection or an X-ray diagnosis apparatus.

### BACKGROUND ART

Conventional X-ray apparatuses such as an X-ray fluoroscopic-radiographic apparatus and an X-ray diagnosis apparatus for the circulatory system are essential in the field of diagnosis. With recent development of medical techniques, these apparatuses are used also in the field of therapy, typically IVR. IVR is fluoroscopic surgery in which a catheter attached with various kinds of therapeutic device on its top is inserted into a blood vessel or an organ of an object. IVR is rapidly prevailing in recent years because therapy is possible without peritoneotomy which has been conventionally necessary.

In the IVR, it is desired to stereoscopically grasp the position and shape of a target part of an object. To this end, a three-dimensional image is taken with an X-ray CT apparatus. The position and shape of the target part of the object are grasped from this three-dimensional image. X-rays are irradiated at various angles to the target part of the object grasped above by using the X-ray diagnosis apparatus for the circulatory system having an X-ray irradiation system and an X-ray detection system supported by a C-character arm. Therapy is performed by referring to a two-dimensional fluoroscopic image of the target part of the object taken with the X-ray diagnosis apparatus for the circulatory system. The therapy result is confirmed by using again the X-ray CT apparatus. The X-ray diagnosis apparatus for the circulatory system is shown in FIGS. 4-7 at page 156 of “Medical Radiogenics Course 13, Radiodiagnosis Apparatus Engineering” by Medical, Dental and Pharmaceutical Publishing K. K.

The X-ray diagnosis apparatus for the circulatory system with said C-character arm is structured to be able to perform various rotation and motion such as arm rotation and sliding motion in order to perform fluoroscopy and radiography along various directions. As described above, prior to surgery, the position and shape of a therapeutic target of the object are confirmed from a three-dimensional image taken with an X-ray CT apparatus. Diagnosis and therapy are performed in accordance with the position and shape obtained with the three-dimensional image and a two-dimensional fluoroscopic image obtained with the X-ray diagnosis apparatus for the circulatory system.

In this method utilizing both the X-ray diagnosis apparatus for the circulatory system and the X-ray CT apparatus, the information obtained during IVR is only the two-dimensional information taken with the X-ray diagnosis apparatus for the circulatory system. Therefore, during the operation, the operator cannot intuitively grasp the position and shape of the therapeutic target of the object or the positional relation between the therapeutic target of the object and the therapeutic device attached to the tip of the catheter.

In order to take a three-dimensional image with the X-ray CT apparatus, a technique referred to as a volume scan or a helical scan is used, in which the three-dimensional image of an object is reconstructed with X-ray transmission data detected while the object is moved along the direction of the axis of the object. However, the X-ray CT apparatus of the volume scan type is associated with a problem of low resolution along the longitudinal axis of the object.

With low resolution, it may be difficult to correctly grasp the position and shape of a therapeutic target of the object. It is therefore desired to further improve the resolution.

In order to improve the resolution, it may be considered to take an image by lowering the motion speed of the object relative to a rotation speed of a radiographic system. However, in this case, quick response necessary for IVR is degraded.

Also, the method utilizing both the X-ray diagnosis apparatus for the circulatory system and the X-ray CT apparatus is associated with a problem in terms of an economic viewpoint and an install space, because the two expensive apparatuses are installed in a large space.

An X-ray apparatus capable of solving said problems associated with the method utilizing both the X-ray diagnosis apparatus for the circulatory system and the X-ray CT apparatus has been proposed in Japanese Patent Application No. Heisei-10-306238. This X-ray apparatus can take both a three-dimensional image of an object and a two-dimensional fluoroscopic image to perform diagnosis and therapy. This apparatus has an X-ray tube as an X-ray source mounted on one end of a support; an image receptor on the other end; and a rotating means for rotating the X-ray source and image receptor. The center part of rotation is provided with a space so that X-ray transmission data can be obtained along the whole circumferential directions of the object. The apparatus is provided with an X-ray image forming means capable of taking not only a two-dimensional fluoroscopic image of the object but also a three-dimensional image (a stereoscopic image along an optional tomographic plane, hereinafter referred to as a cone beam CT image).

In this apparatus, the center part of rotation of the rotating means supporting the radiographic system is provided with the space in which the object can be subjected to a relative motion. Only by horizontally moving the object in parallel to the rotation center axis of the rotating means or by horizontally moving the rotating means in parallel to the rotation center, the imaging area of the radiographic system can be moved from the head to feet of the object. X-ray transmission data is thus collected along the whole circumferential directions at an optional position, and input to the X-ray image forming means to obtain a three-dimensional image of the object with known reconstruction calculations. When the fluoroscopic direction of the therapeutic target of the object is determined from the three-dimensional image, the rotary position of the support is fixed to the position along the fluoroscopic direction to perform fluoroscopy along the direction determined by the rotary position and obtain a two-dimensional image.

By using this apparatus, the position and shape of a therapeutic target of the object are grasped from the three-dimensional image and in accordance with this image, and therapy is performed by referring to the two-dimensional image. The therapy result is confirmed by taking the three-dimensional image with the method described above without moving the object.

During IVR, the position and shape of a therapeutic target of the object are grasped from the three-dimensional image, and the grasped therapeutic target is remedied while looking at two-dimensional fluoroscopic images taken along multiple directions. However, although the X-ray apparatus proposed in Japanese Patent Application No. Heisei-10-306238 can take a fluoroscopic image at an optional angle around the rotation center axis (along a direction perpendicular to the longitudinal axis of the object), it cannot take a fluoroscopic image at an optional angle along the head-feet direction.

Since a fluoroscopic image at an oblique angle to the longitudinal axis of the object cannot be taken, the therapeutic part cannot be observed at the oblique angle, so that the therapy range of IVR is limited. Namely, the apparatus is not provided with a function of inclining the X-ray source and the X-ray image receptor along the direction of the longitudinal axis of the object to make the X-ray source and the X-ray image receptor face each other. Therefore, a blood vessel or the like cannot be drawn along the above-described fluoroscopic direction.

### DISCLOSURE OF THE INVENTION

An object of the present invention is to solve the above problems and provide an X-ray apparatus suitable for IVR, capable of taking both a three-dimensional image and a two-dimensional image and capable of changing the fluoroscopic angle relative to the direction of the longitudinal axis of the object.

The above and other objects and novel features of the present invention will be clear in the description of this specification and the accompanying drawings.

(1) In an X-ray apparatus having a radiographic system constituted of an X-ray source mounted on one end of a rotary member for radially irradiating an X-ray to an object and image receiving means mounted on the other end of the rotary member for radiographing an X-ray image of the object, the rotary member having a space in a rotation center area for relatively moving the object, the X-ray apparatus further comprises an X-ray image forming means for forming a three-dimensional X-ray image of the object from an X-ray image taken by rotating the radiographic system around the object, and placing means (a table device) for placing the object and setting a desired angle between a rotation center axis of the radiographic system and the direction of a longitudinal axis of the object.

(2) In the X-ray apparatus described in (1), said placing means includes revolving means for revolving said object around an X-ray irradiation field center axis perpendicular to a floor surface on which the radiographic system is installed.

(3) In the X-ray apparatus described in (2), said revolving means comprises arc orbits disposed on the floor on which the placing means is installed, and means disposed on the placing means for revolving along the orbits.

(4) In the X-ray apparatus described in (3), said arc orbits of the revolving means are disposed in such a manner that a center axis of the arc orbits passes through an isocenter of the radiographic system that comprises said X-ray source and image recieving means, said isocenter being perpendicular to the floor.

(5) In the X-ray apparatus described in any one of (1) to (4), said rotary member comprises a supporting member with cylindrical shape of which rotation center is coincident with that of the radiographic system, the first supporting member which extends from the supporting member with cylindrical shape and supports said X-ray source at the one end of it, and the second supporting member which extends from the supporting member with cylindrical shape and supports said image receiving means.

According to the above-described means (1) to (5), the space for relatively moving the object is formed in the rotation center area of the rotary member supporting the radiographic system. An X-ray image can be imaged along a desired direction at a desired position by horizontally moving the object in parallel to the rotation center axis or by revolving the table device along the arc orbits. The diameter of the rotary member does not have to be increased by horizontally moving the table. A three-dimensional X-ray image of an imaged area can be obtained from an X-ray image of an object taken at a desired angle with an X-ray image forming means through reconstruction calculations. For example, even during IVR, the three-dimensional X-ray image of an object can be obtained without moving the object.

On the other hand, in the fluoroscopy and radiography, the angle of the longitudinal axis of the object to the rotation center axis of the radiographic system can be set optionally by revolving the placing means (table device) for placing an object. It is thus possible to move the fluoroscopic angle and radiographic angle in fluoroscopy and radiography along the head-feet direction of the object by rotating the radiographic system. As a result, it is possible to perform fluoroscopy or radiography by inclining the fluoroscopic angle or radiographic angle to the direction of the longitudinal axis of the object. A blood vessel or the like can be drawn along the direction of the longitudinal axis of the object. Namely, diagnosis information of complicatedly entangled blood vessels, organs or the like can be richly obtained so that the efficiency of diagnosis and therapy can be improved.

The effects of the typical invention disclosed in this application are briefly described in the followings:

(1) It is possible to set the fluoroscopic angle or radiographic angle to the direction of the longitudinal axis of the object, and to obtain both a three-dimensional image and a two-dimensional image at this angle with the same apparatus.

(2) Diagnosis information of complicatedly entangled blood vessels, organs or the like can be obtained.

(3) The efficiencies of diagnosis and therapy can be improved.

### BRIEF DESCRIPTION OF THE DRAWINGS

FIG. 1 is a perspective view showing the contour structure of an X-ray apparatus according to the first embodiment of the present invention.

FIGS. 2A and 2B are diagrams illustrating the fluoroscopic and radiographic operations of the X-ray apparatus in the first embodiment.

FIGS. 3A and 3B are diagrams illustrating the contour structure of a rotation mechanism in the first embodiment.

FIG. 4 is a functional block diagram of a control unit and an image processing unit of the X-ray apparatus in the first embodiment.

FIG. 5 is a flow chart illustrating the rotary motion of a radiographic system of the X-ray apparatus in the first embodiment.

FIGS. 6A, 6B and 6C are diagrams illustrating the contour structure of a revolving mechanism of a table device of the X-ray apparatus in the first embodiment.

FIG. 7 is a diagram showing the contour structure of a table device of an X-ray apparatus according to the second embodiment of the present invention.

### BEST MODE FOR CARRYING OUT THE INVENTION

The invention will be described in detail in connection with modes embodying the invention (embodiments) by referring to the attached drawings.

In all the drawings to be used for describing the embodiments of the invention, elements having the same function are represented by identical reference numerals and the duplicated description is omitted.

(First Embodiment)

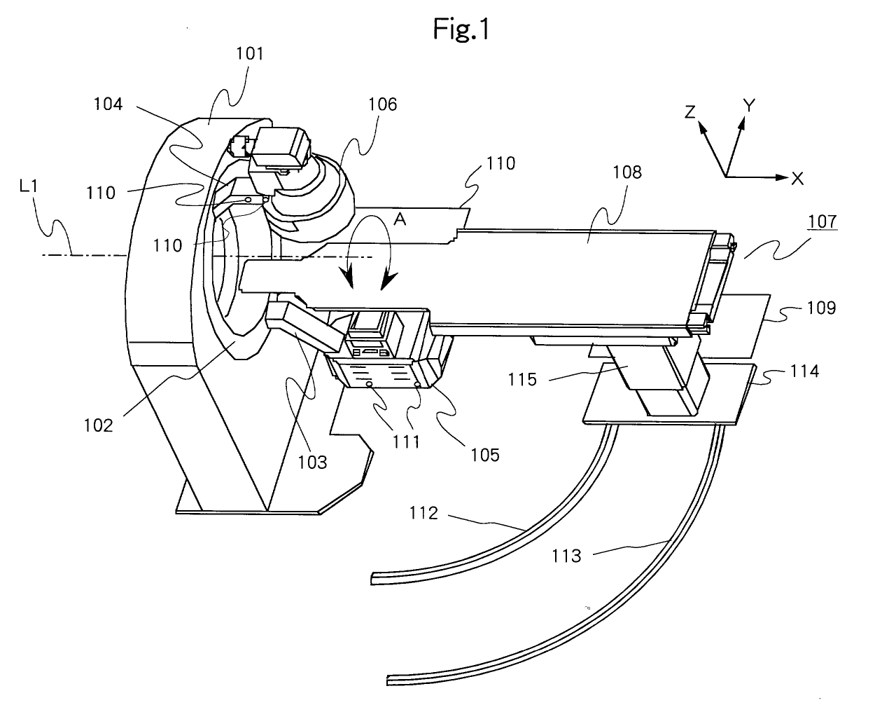

FIG. 1 is a perspective view showing the contour structure of an X-ray apparatus according to the first embodiment of the present invention. Reference numeral 101 represents a stand, 102 represents a rotary ring, 103 represents the first arm, 104 represents the second arm, 105 represents an X-ray source (an X-ray tube), 106 represents an X-ray detector (image receiving means), 107 represents a table device (placing means), 108 represents a top plate, 109 represents a mat switch, 110 and 111 represent obstacle detecting sensors, 112 represents the first rail, 113 represents the second rail, 114 represents a table device mount base, and 115 represents a top plate lift. X, Y and Z represent the X-axis, the Y-axis and the Z-axis. In this embodiment, a support for the radiographic system constituted of the X-ray source 105 and the X-ray detector 106 comprises the first arm 103, the second arm 104 and the rotary ring 102.

In FIG. 1, the stand 101, which is installed upright on the floor, has a rotation mechanism (rotatively moving means) for rotating the rotary ring 102 along its shape.

The rotary ring 102 has an opening around the rotation center axis L1, and it has the first and the second arms 103 and 104 on the side where the table device 107 is set.

The first arm 103 has the X-ray source 105 on one end, and the other end of the first arm 103 is fixed to the rotary ring 102. The first arm 103 supports said X-ray source 105 in such a manner that the center of an X-ray irradiation field of the X-ray source 106 passes through the rotation center axis L1.

The second arm 104 has the X-ray detector 106 on one end, and the other end of the second arm 104 is fixed to the rotary ring 102. The second arm 104 supports the X-ray detector 106 at the position facing the X-ray source 105 through the rotation center axis L1.

The X-ray source 105 is an X-ray tube for irradiating an X-ray radially (conically, or prismatically) toward an object that is not described in the figure. This X-ray source is disposed at the position facing the X-ray detector 102 through the undescribed object set to the top plate 108. Also, the X-ray source 105 in the first embodiment has a motion mechanism for moving the X-ray source 105 along the direction of a line coupling the rotation center axis L1 and the X-ray source 105.

The X-ray detector 106 is a known X-ray detector constituted of an X-ray image intensifier (X-ray I. I.), an optical lens system and a television camera. This X-ray detector 106 detects a two-dimensional X-ray image that transmitted through the undescribed object set on the top plate 108 and converts it into electrical signals. Also, the X-ray detector 106 in the first embodiment is provided with a known motion mechanism for moving the X-ray detector 106 along the direction of a line connecting the rotation center axis L1 and the X-ray detector 106. It is obvious that although the system constituted of the X-ray I. I. and television camera is used as the X-ray detector 106 in the first embodiment, a two-dimensional X-ray detector using TFT elements (a flat panel X-ray detector) or the like may be also used.

The table device 107 performs lift motion of the top plate 108 to set the height (motion along the Z axis direction shown in FIG. 1) of the object to the height of the center of the radiographic system, and performs horizontal motion along the X-axis direction to transfer the object into the radiographic field. This table device 107 supports the top plate 108 in the manner that its longitudinal direction is set to the rotation center axis L1 direction. In order to prevent the lift 115 of the table device 107 from obstructing the rotation of the radiographic system, the top plate 108 is supported with a cantilever method. This top plate 108 has the shape that the width of the area where the head of an object is placed is narrowed and the width of the whole plate is gradually broadened toward the area where the feet of the object are placed in order to prevent the top plate 108 from obstructing the rotation of the radiographic system.

The table device 107 has the structure that it is supported to be able to revolve in the horizontal plane by using as its revolution center an isocenter of the X-ray source 105 and X-ray detector 106 constituting the radiographic system. More specifically, the two arc rails made of the first and the second rails 112 and 113 are disposed on the floor. And blocks movable along the first or the second rail 112, 113 are mounted on the bottom of the mount base 114 on which the lift 115 is mounted. With this arrangement, the table device 107 can be moved along the first and the second rails 112 and 113, i.e., it can be revolved around the isocenter. The details of the mechanism for revolving the table device 107 in the horizontal plane will be later given.

The mat switches 109 and 110 each outputs a signal when a pressure is applied to the upper surface. The mat switches are used as a safety mechanism for checking that an object or the like is not positioned in a rotation area while the radiographic system is rotated by 360 degrees around the object.

The obstacle detecting sensor 111 is generally a photoelectric sensor, an electrostatic capacitance sensor, an ultrasonic sensor or the like. In this embodiment, an electrostatic capacitance sensor is used because it has high detection stability and can detect a wide variety of objects. This kind of sensor has an electrode therein and detects an electrostatic capacitance formed between the electrode and obstacles. This sensor in this embodiment detects a presence of an obstacle in the rotation area of the X-ray source 105 and the X-ray detector 106.

The table device 107 is disposed in such a manner that the top plate 108 supported in a cantilever manner is disposed on the X-axis side, i.e., the lift 115 is remotest from the stand 101. The table device 107 sets the height of an object to the center of the radiographic system and horizontally moves the object to the pickup area of an X-ray image from the head side of the object. The head of the object may enter into the rotary ring 102 depending upon the pickup area. But, in the X-ray apparatus in this embodiment, the rotary ring 102 only rotatably supports the X-ray tube 105 and the X-ray detector 106. It is therefore possible to shorten the length of the rotary ring 102 along the X-axis direction, i.e., shallow the depth. Even if the chest or abdomen of the object is positioned in the pickup area with the head of the object being inserted through the rotary ring 102, the behavior such as a face expression of the object can be observed easily so that a rapid change in the condition of the object can be dealt with quickly.

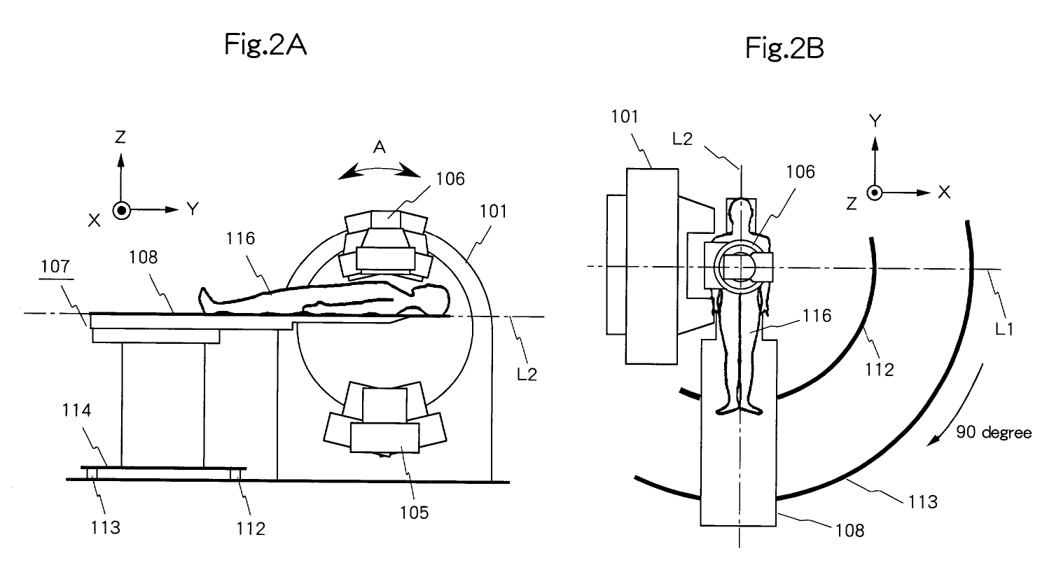

FIG. 2 is a diagram illustrating the fluoroscopic and radiographic operations of the X-ray apparatus in the first embodiment. Particularly, FIG. 2A is a side view of the X-ray apparatus as viewed along the X-axis direction, and FIG. 2B is a top view of the X-ray apparatus as viewed along the Z-axis direction.

In FIGS. 2A and 2B, reference numeral 116 represents the object. FIGS. 2A and 2B show the positional relation between the radiographic system and the object 116 when the table device 107 is revolved clockwise by 90 degrees as indicated with an arrow in FIG. 2B, i.e., by revolving the object 116 to the left.

As is clear from FIGS. 2A and 2B, the X-ray apparatus in the first embodiment is structured in such a manner that the table device 107 is slidable along the first and the second rails 112 and 113 of the arc shape having as its center axis a perpendicular passing through the isocenter of the radiographic system. Therefore, as shown in FIG. 2B, when the table device 107 is revolved by 90 degrees along the arrow direction, the rotation center axis L1 and the longitudinal axis L2 of the object 116 are perpendicular at the isocenter. Namely, the longitudinal axis L2 of the object 116 is included in the rotation plane of the radiographic system. But during the image pickup involving a motion of the table device 107, the X-ray detector 106 is, for example, disposed above the top plate 108 and the X-ray source 105 is disposed below the top plate 108. Especially the X-ray detector 106 is at the highest position and the X-ray source 105 is at the lowest position. By revolving the table device 107 under the condition that the center axis of the X-ray irradiation field of the radiographic system corresponds to the center axis of the first and second rails 112 and 113, it is possible to minimize or eliminate blurring of the center position of a fluoroscopic image or a radiographic image that is caused by revolution of the table device 107.

As shown in FIG. 2A, when the radiographic system is rotated clockwise or counter-clockwise as indicated with an arrow A, the rotation plane of the radiographic system is the plane including the longitudinal axis of the object 116. It is therefore possible to change the angle between the center axis of the X-ray irradiation field of the radiographic system and the object 116 in the ZY plane. Namely, by rotating the radiographic system, the fluoroscopic angle or the radiographic angle in the fluoroscopy or the radiography can be moved along the head-feet direction of the object 116.

As a result of it, the fluoroscopy or the radiography can be performed by inclining the fluoroscopic angle or the radiographic angle to the longitudinal axis L2 of the object 116. A blood vessel or the like can be extracted at a desired angle against the longitudinal axis L2 of the object 116. Namely, diagnosis information of complicatedly entangled blood vessels, organs or the like can be obtained richly, so that the efficiency of diagnosis and therapy can be improved.

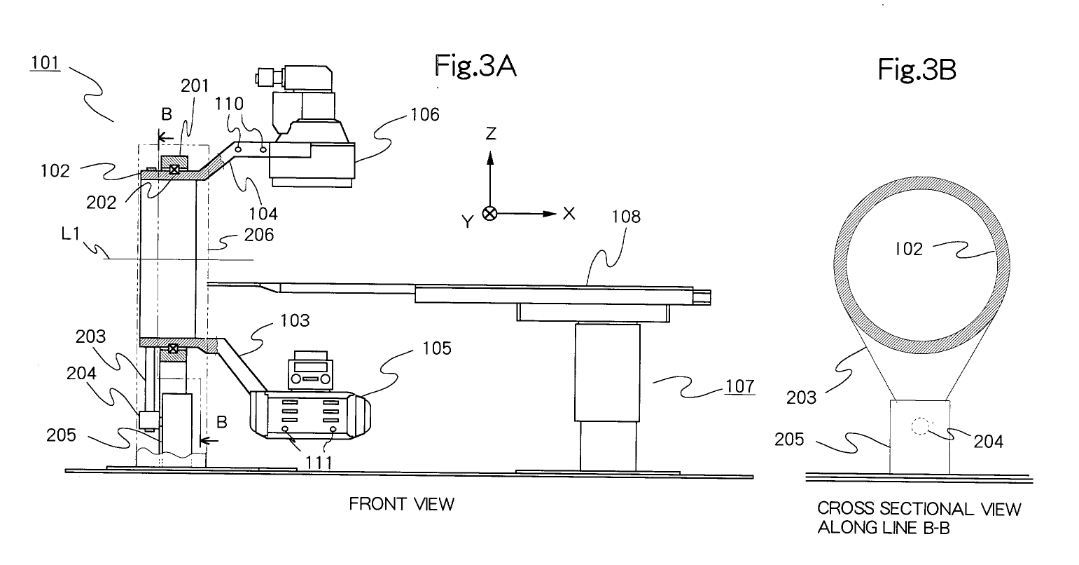

FIGS. 3A and 3B are diagrams showing the contour structure of the rotation mechanism of the radiographic system. FIG. 3A is a front view showing the sectional structure of the rotation mechanism, and FIG. 3B is a cross sectional view taken along the line BB shown in FIG. 3A.

In FIG. 3A, reference numeral 201 represents a frame, 202 represents a bearing, 203 represents a belt, 204 represents a drive pulley, 205 represents a motor, and 206 represents a cover.

As is clear from FIG. 3A, in the rotation mechanism in this embodiment, the frame 201 is disposed upright on the floor. This frame 201 supports the rotary ring 102 in such a manner that the rotation center of the rotary ring 102 corresponds to the rotation center axis L1. A hole having almost the same diameter as that of the rotary ring 102 is formed in the frame 201. The rotary ring 102 is inserted into this hole. A groove is formed along the circumference of the hole in the inner circumferential plane of the hole of the frame 201. And also, a groove is formed along the circumference of the hole in the outer circumferential plane of the rotary ring 102. By inserting the bearing 202 into the groove of the rotary ring 102 inserted into the frame 201 and the groove of the frame 201, the rotary ring 102 can be rotated. The motor 205 is installed at the bottom of the frame 201 and the drive pulley 204 is coupled to the rotary shaft of the motor 205. As shown in FIG. 3B, the belt 203 extends between the drive pulley 204 and the rotary ring 102. With the rotation of the belt 203, the rotary ring 102 is rotated by rotating the motor 205.

These components are covered with the cover 206. Only the front of the rotary ring 102, i.e., the side mounting the first and the second arms 103 and 104 are exposed.

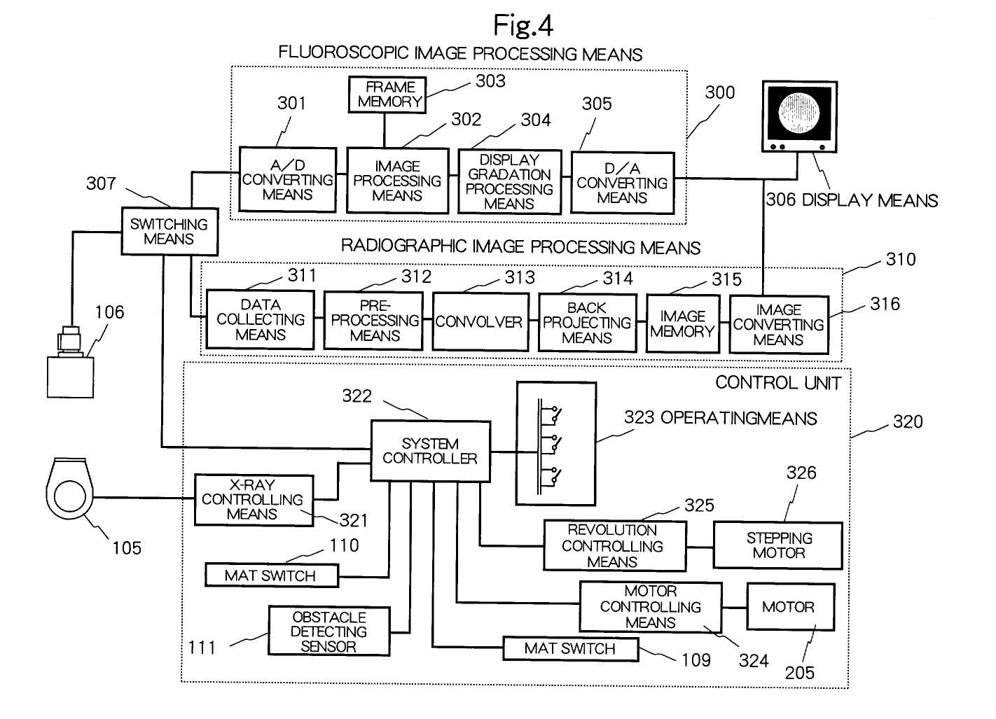

FIG. 4 is a functional block diagram of a control unit and an image processing unit of the X-ray apparatus in the first embodiment. Reference numeral 300 represents a fluoroscopic image processing unit, 310 represents a radiographic image processing unit, 320 represents a control unit, 301 represents an A/D converting means, 302 represents an image processing means, 303 represents a frame memory, 304 represents a display gradation processing means, 305 represents a D/A converting means, 306 represents a display means, 307 represents a switching means, 311 represents a data collecting means, 312 represents a pre-processing means, 313 represents a convolver, 314 represents a back projecting means, 315 represents an image memory, 316 represents an image converting means, 321 represents an X-ray controlling means, 322 represents a system controller, 323 represents an operating means, 324 represents a motor controlling means, 325 represents a revolution controlling means, and 326 represents a stepping motor. In the X-ray apparatus in the embodiment, the fluoroscopic image processing unit 300 has the same structure as a conventional fluoroscopic image processing unit. Therefore, in the following description, the radiographic image processing unit 310 and the control unit 320 having structures different from conventional ones will be described in detail.

In FIG. 4, the switching means 307 operates to output an analog signal (an analog X-ray image) output from the X-ray detector 106 either to the fluoroscopic image processing unit 300 or to the radiographic image processing unit 310 in accordance with a switching control signal output from the system controller 322. The switching means is, for example, composed of an analog switch. The switching control signal output from the system controller 322 is determined from an instruction of fluoroscopy, radiography, tomography, or three-dimensional imaging input from operating means 323.

The data collecting means 311 is constituted of an A/D converting means for converting an analog signal into a digital signal and a storage means for storing an X-ray image converted into digital signals (hereinafter called “projection data”). The data collecting means 311 sequentially converts X-ray images taken by rotating the radiographic system by 360 degrees around the object into digital signals (projection data) and stores them. This data collecting means 311 can be realized, for example, with an A/D converter, a storing device and a program for sequentially storing an X-ray image to which A/D conversion is performed.

The pre-processing means 312 performs preprocesses such as gain correction, offset correction, gamma correction, image distortion correction, logarithmic conversion and sensitivity non-uniformity correction to the projection data collected by data collecting means 311.

The convolver 313 is an accumulating means for correcting blur of projection data by accumulating a preset weighing function such as Sheep and Logan to the pre-processed projection data.

The back projecting means 314 sequentially adds the input values to reversely project the projection data after blur correction, and thus generate an X-ray absorption coefficient distribution image in the pickup area called a CT image or a three-dimensional image. In this embodiment, therefore, the convolver 313 and the back projection means 314 perform reconstruction calculations to reconstruct the tomographic image in the pickup area. As the reconstruction calculation method for a tomographic image, for example, an image reconstruction calculation method called a convolution method or the like is utilized. As the reconstruction calculation method for a three-dimensional image, a cone beam reconstruction method by Feldkamp or the like is utilized. This method is described in “Practical cone beam algorithm” by L. A. Feldkamp et al., J. Opt. Soc. Am. A, Vol. 1, No. 6, pp 612-619, 1984 (hereinafter referred to as the document 1). In this embodiment, in response to an instruction for radiography or display instruction input from the operating means 323, it is possible to select reconstruction of either a three-dimensional X-ray image or a tomographic image, as well as to reconstruct both X-ray images and to display them on the same screen.

The image memory 315 stores an CT image. It can be realized, for example, by an external storage device such as a semiconductor memory, a magnetic disc, an optical disc and a magneto-optical disc.

The image converting means 316 has a three-dimensional X-ray image forming means which performs a process such as a volume rendering process or a maximum value projection process for converting a three-dimensional image reconstructed through reconstruction calculations into a three-dimensional absorption distribution image which is a two-dimensional image; and a level converting means for converting a CT image and a three-dimensional absorption distribution image into images recognizable with human eyes by changing distribution data of X-ray absorption coefficients to gradation levels recognizable human eyes. The function of each means of the radiographic image processing unit 310 can be realized by hardware or software.

In accordance with a radiographic mode input from the operating means 323, the system controller 322 controls the switching means 307 to control the display mode of an X-ray image taken with the X-ray detector 106, and also controls the motor controlling means 324 to control the operation of the radiographic system, i.e., to control the X-ray image taken with the X-ray detector 106. Also, in accordance with the detection outputs from the mat switches 109 and 110 and the obstacle detecting sensor 111, the system controller 322 judges whether the rotation of the rotary ring 102 can be permitted or not. Also, in accordance with a revolution instruction of the table device 107 input from the operating means 323, the system controller 322 controls the revolution controlling means 325 to control revolution of the table device 107. A drive signal output from the revolution controlling means 325 drives the stepping motor 326 installed in an undescribed sliding mechanism to slide the table device 107 along the first and the second rails 112 and 113. The details of the sliding mechanism will be given later.

Next, with reference to FIG. 4, the operation of the X-ray apparatus in the embodiment shown in FIGS. 1 to 3A and 3B in a fluoroscopic and radiographic mode (during X-ray inspection for the circulatory system) will be described.

First, in response to a motor rotation instruction input from the operating means 323, the system controller 322 instructs the motor controlling means 324 to operate. Then, in response to the operation instruction from the system controller 322, the motor controlling means 324 drives the motor 205 to set the radiographic system (the X-ray tube 105 and the X-ray detector 106) to a designated angle.

Next, in response to a projection start instruction from the operating means 323, the system controller 322 instructs the X-ray controlling means 321 to drive the X-ray tube 105, and switches an output of the switching means 307 to the side of the fluoroscopic image processing unit 300.

The X-ray irradiated from the X-ray tube 105 transmits through an undescribed object set to the top plate 108, and it is detected (imaged) as a two-dimensional X-ray image by the X-ray detector 106. The two-dimensional X-ray image detected with the X-ray detector 106 is output as analog electrical signals which are supplied through the switching means 307 to the A/D converting means 301 whereat the analog electrical signals are converted into a digital two-dimensional image, i.e., projection data. This projection data is sequentially stored into the frame memory 303 connected to the image processing means 302. After the projection data for one frame is collected, the image processing means 302 sequentially reads out the projection data by one frame from the frame memory 303. After the image processing means 302 performs image processes such as contrast correction and gamma characteristic conversion, the image processing means outputs the processed projection data to the display gradation processing means 304. The display gradation processing means 304 corrects the gradation of the input projection data and outputs it to the D/A converting means 305 whereat the projection data is converted into video signals, which are displayed as a two-dimensional projection image on the screen of the display means 306. The above operations are sequentially performed to display a projection image.

In this case, if the radiographic mode is set, the projection data output from the display gradation processing means 304 is stored in an undescribed external storage device such as a magnetic disc and a magneto-optical disc to perform radiography.

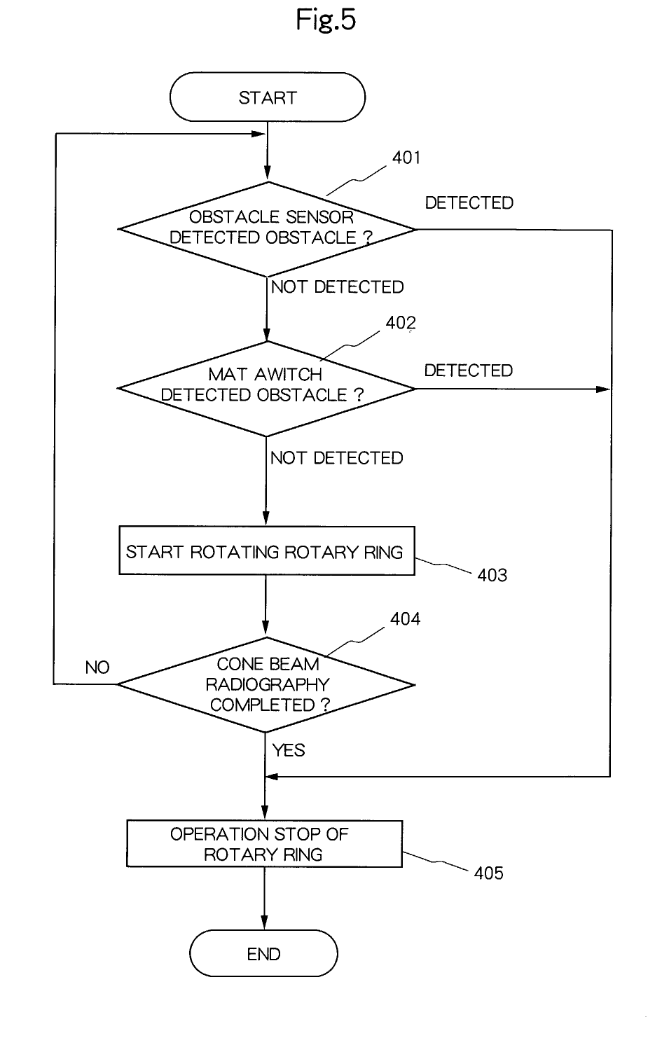

FIG. 5 is a flow chart illustrating the rotation operation of the radiographic system of the X-ray apparatus in the first embodiment. With reference to FIG. 5, the description will be made for the operation of the X-ray apparatus in the embodiment to radiograph a three-dimensional X-ray image and a tomographic image (during rotation imaging).

This flow starts in response to the instruction for radiography from the operating means 323. First, in accordance with an output from the obstacle detecting sensor 111, the system controller 322 judges whether the obstacle detecting sensor 111 detects an obstacle, i.e., whether there is an object, a surgery instrument or the like in the rotation area of the radiographic system (Step 401). If the obstacle detecting sensor 111 detects no obstacle, the system controller 322 then judges whether the mat switches 109 and 110 detect an obstacle, i.e., whether an object or the like exists in the rotation area of the radiographic system (Step 402). If the mat switches 109 and 110 detect no obstacle, the system controller 322 then controls the switching means 307 to switch an output of the X-ray detector 106 to the side of the data collecting means 311. Next, the system controller 322 instructs the motor control means 324 to rotate the motor 205, and instructs the X-ray controlling means 321 to drive the X-ray tube 105. In response to this instruction, the X-ray controlling means 321 supplies the X-ray tube 105 with a driving current to radially irradiate an X-ray to the object. The motor controlling means 324 supplies the motor with a rotation current to rotate the motor. A rotation driving force of the motor is transmitted through the belt 203 to the rotary ring 102 in order to rotate the radiographic system around the object. The data collecting means 311 input with an X-ray image from the X-ray detector 106 converts the X-ray image into projection data at a predetermined rotary angle interval and stores it in the storage means. In this manner, the projection data of the object taken by using as the rotation center the rotation center axis L1 can be collected (imaging) (Step 403). When the end of cone beam radiography is instructed after projection data for one rotation is collected (Step 404), the system controller 322 controls the motor controlling means 324 to stop the rotation of the motor 205 (Step 405) to thereafter terminate this flow and complete the collection of the projection data from the whole circumference of the object.

The projection data stored in the storage means of the data collecting means 311 is subjected to the pre-process by the pre-processing means 312 such as gain correction, offset correction, gamma correction, image distortion correction, logarithmic conversion and sensitivity non-uniformity correction, and then output to the convolver 313. Blur of the processed projection data is corrected by the convolver 313. Thereafter, the back projecting means 314 performs back projection calculations to store the data as a three-dimensional image in the image memory 315. For this three-dimensional image, the three-dimensional X-ray image forming means of the image converting means 316 performs a volume rendering process, a maximum value projecting process or the like in order to convert the three-dimensional image into a three-dimensional absorption distribution image which is a two-dimensional image. Thereafter, the level converting means converts the three-dimensional absorption distribution image into an image recognizable with human eyes by changing distribution data of X-ray absorption coefficients to gradation levels recognizable with human eyes. A three-dimensional X-ray image is therefore displayed on the screen of the display means 306.

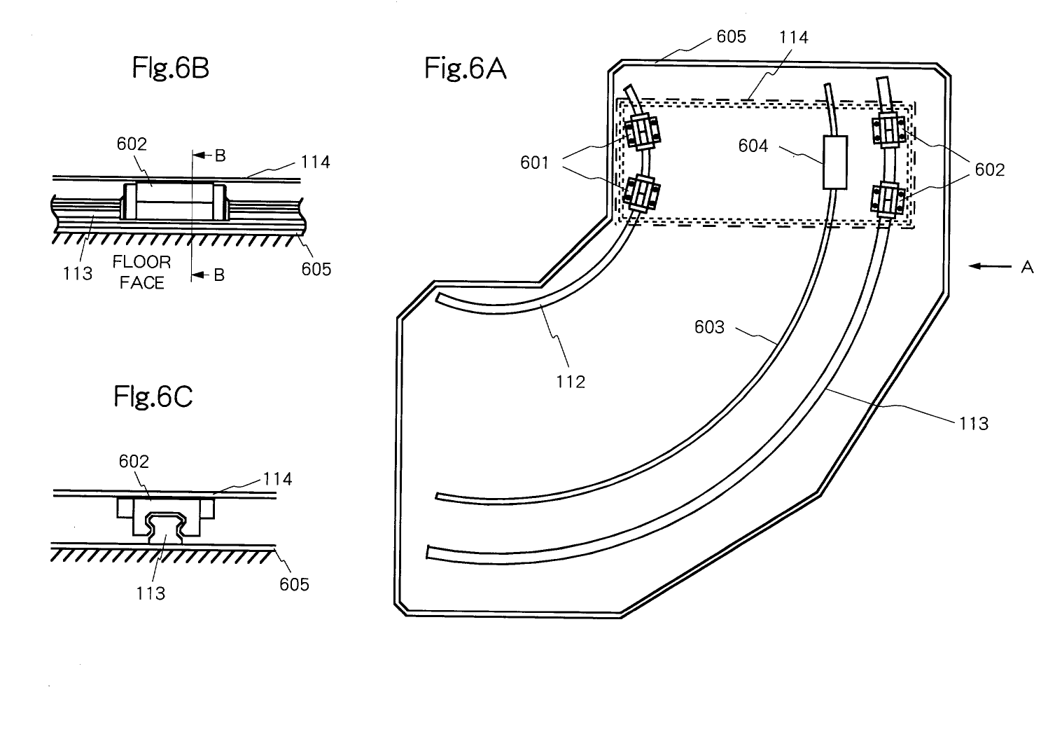

FIGS. 6A, 6B and 6C are diagrams showing the contour structure of the revolution mechanism of the table device of the X-ray apparatus in the first embodiment. FIG. 6A is a top view showing the contour structure of the revolution mechanism, FIG. 6B is a side view of FIG. 6A as viewed along the direction A, and FIG. 6C is a front view of FIG. 6B as viewed along the direction B.

In FIG. 6A, reference numeral 601 represents the first blocks, 602 represents the second blocks, 603 represents a gear rail, 604 represents a slide rail, and 605 represents an install base. The first blocks 601 are slidably disposed on the first rail 112, and the second blocks 602 are slidably disposed on the second rail 113. In the revolution mechanism in the embodiment, the gear rail 603 is disposed between the first and the second rails 112 and 113, the gear rail being of an arc shape having as its center axis a perpendicular passing the isocenter of the radiographic system. Gear teeth racks are formed on the upper surface of the gear rail 603 and engage with an undescribed pinion of the sliding mechanism 604 disposed on the bottom side of the table device mount base 114.

The sliding mechanism 604 is, for example, constituted of the stepping motor 326, a gear mechanism for transmitting the rotation of the stepping motor 326 to the undescribed pinion engaged with the gear rail 603 and a detector for detecting a motion amount of the table device 107. Namely, in accordance with the driving signal output from the revolution controlling means 325, the stepping motor 326 is driven to be rotated. This drive force is transmitted to the undescribed pinion engaging with the gear rail 603 by the gear mechanism. Therefore, the table device 107 moves along the first and the second rails 112 and 113.

In the X-ray apparatus in this embodiment, for example, as shown in FIGS. 6B and 6C, the first and the second rails 112 and 113 have cross sectional shapes like a bobbin having a narrower width of a middle portion than the widths of the upper and lower portions. The upper surfaces of the first and the second rails 112 and 113 are flat. The first and second blocks 601 and 602 each have a known guide which squeezes the narrower width portion of each of the first and the second rails 112 and 113. Therefore, the first and the second blocks 601 and 602 can support the load along the gravitation direction and along its opposite direction, as well as along a moment direction so that the top plate 108 can be supported with the cantilever method. The structure of the guide is not limited only to one shown in FIGS. 6B and 6C. Obviously, it is also possible to use a guide having another structure (mechanism) so long as it can support the load along the gravitation direction, along its opposite direction and along the moment direction to support the top 108 by the cantilever method.

As described above, according to the X-ray apparatus in the first embodiment, an X-ray image can be imaged by rotating the radiographic system around the object at a desired position, without increasing the distance from the rotary ring 102 at one fulcrum of the cantilever to the top of each arm. Therefore, it is possible to ensure the safety of the object, to make the apparatus compact, and to install the apparatus in a narrow area.

Also, by moving the top plate 108 in the direction (X-axis direction) of the rotation center axis L1, in case of rotation imaging of, for example, feet of an object, it is possible to perform rotation image, and by moving the top plate 108 in a direction opposite to the X-axis direction, i.e., such that an area from the chest to the abdomen of the object is entered into the rotary ring 102. Therefore, without resetting the position of the object, the area from the feet to head can be subjected to rotation imaging. Without elongating the arms supporting the X-ray tube 105 and the X-ray detector 106, the optical position from the feet to head can be subjected to rotation imaging. According to the X-ray apparatus in the first embodiment, therefore, a three-dimensional X-ray image of an imaging area can be obtained from an X-ray image of the object taken from 360 degrees with the radiographic image processing unit 310 through known reconstruction calculations. Therefore, for example, even during IVR the three-dimensional X-ray image of the object can be obtained without moving the object.

Also, in the X-ray apparatus in the first embodiment, the X-ray tube 105 and the X-ray detector 106 are supported only by the first and the second arms 103 and 104. Therefore, a broad space can be given for a surgery operator of the object. And it is also possible to quickly deal with the rapid change in the condition of the object.

Further, according to the X-ray apparatus in the first embodiment, the first and the second blocks 601 and 602 are disposed on the bottom surface of the mount base 114 so that the table device 107 can be revolved along the first and the second rails 112 and 113 of the arc shape having as its center axis the perpendicular passing through the isocenter of the radiographic system. Then, it is possible as shown in FIG. 2A to change as desired the angle between the X-ray irradiation center axis of the radiographic system and the longitudinal axis of the object 116 in the ZY plane. Accordingly, fluoroscopy and radiography are possible with inclining the fluoroscopic angle or radiographic angle to the longitudinal axis L2 of the object 116, and so a blood vessel or the like having an acute angle to the longitudinal axis L2 of the object 116 can be drawn. Namely, diagnosis information of complicatedly entangled blood vessels, organs or the like can be obtained richly, so that the efficiency of diagnosis and therapy can be improved.

In the X-ray apparatus in the first embodiment, the table device 107 can be supported to be able to rotate around the isocenter by the first and the second rails 112 and 113 projecting on the floor and the first and the second blocks 601 and 602 disposed on the bottom surface of the mount base 114. However, the present invention is not limited only to this structure. For example, arc grooves having the isocenter as its center axis may be formed on the floor and projections fitted in the grooves are formed on the bottom surface of the table device mount base 114 and also a horizontal body having a bearing is formed on one end of each projection so that the projection will be not dismounted from the arc groove. In this manner, projections on the floor can be omitted.

Also, in this embodiment, although the revolution range of the table device 107 is set to be 90 degrees from the rotation axis of the radiographic system to the direction perpendicular to the rotation axis, the invention is not limited only thereto. For example, by elongating the first and the second rails 112 and 113, the revolution position of the table device 107 can be extended by −90° along the direction opposite to the direction shown in FIG. 2B, or can be limited only to −90°.

Further, although the table device 107 is revolved around the isocenter by the revolution mechanism in this embodiment, an undescribed surgery operator may manually move the table device 107 by using the first and the second rails 112 and 113 and the blocks disposed on the bottom surface of the table device mount base 114. With this arrangement, for example, a braking mechanism may be provided for squeezing the first and/or the second rail 112, 113. Then, the braking mechanism can solve the problem such as changing the fluoroscopic and radiographic angle during fluoroscopy and radiography. Obviously, the braking mechanism may be constituted of an iron plate placed on the floor and a magnet formed on the bottom surface of the table device mount base 114 at the position corresponding to the iron plate.

(Second Embodiment)

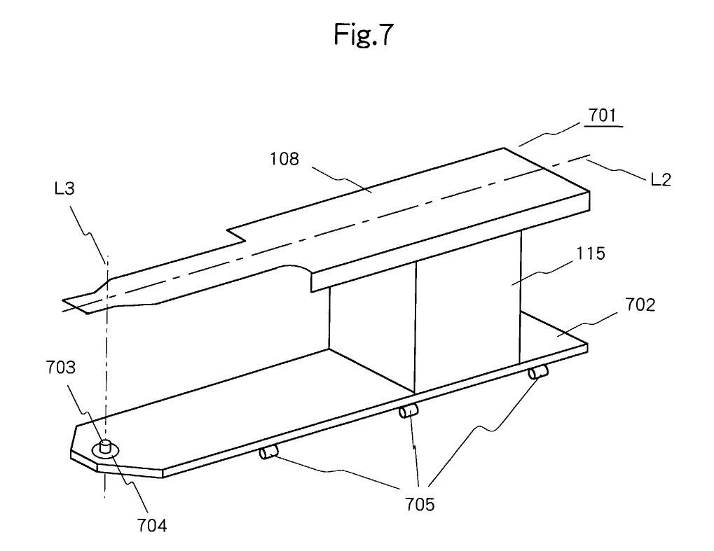

FIG. 7 is a diagram showing another embodiment of the table device of the X-ray apparatus according to the present invention. Reference numeral 701 represents a table device, 702 represents a mount base, 703 represents a rotary shaft, 704 represents a bearing, and 705 represents rollers.

As shown in FIG. 7, the rotary shaft 703 of the table device 701 is fixed to the floor at the position where the floor and an axis L3 within the perpendicular to the floor passing through the isocenter of the radiographic system are crossed.

A plurality of the roller 705 are disposed on the bottom surface of the mount base 702 so that the table device 701 can move on the floor on which the X-ray apparatus is installed. An undescribed stepping motor 326 and a gear mechanism for transmitting a drive force of the stepping motor 326 to at least one of the rollers 705 are disposed on the mount base 702 or in the lift 115. Revolving drive force from the revolution controlling means 325 drives the roller or rollers 705.

Similar to the top plate 108, the mount base 702 extends along the extension direction of the top plate 108. The lift 115 is disposed on one side of the mount base 702 thereof to support the top plate 108 in the cantilever method.

Therefore, the table device 701 in the second embodiment moves along the rotation direction of the rollers 705 when the stepping motor is driven to be rotated by drive output from the revolution controlling means 325 and this drive force is transmitted to the roller or rollers 705 by the gear mechanism. At this time, the table device 701 rotates around the rotation axis 703. Since it is easy to change the angle between the X-ray irradiation center axis in the rotation plane of the radiographic system and the object 116, the effects similar to the already described X-ray apparatus of the first embodiment can be obtained.

The invention made by the inventors has been described above specifically in connection with the embodiments. However, the present invention is not limited only to the embodiments, and various modifications are possible unless departing from the essentials of the present invention.

Although the rotary member in the embodiments has the opening in the central area, this opening is not necessarily required. Also, the opening is not limited only to a through hole, but a large cavity may be used instead.

### INDUSTRIAL APPLICABILITY

The X-ray apparatus of the present invention can be applied not only to medical fields but also to industrial fields.

1. An X-ray apparatus comprising:
a radiographic system having an X-ray source mounted on one end of a rotary member for radially irradiating X-ray to an object and image receiving means mounted on another end of the rotary member for receiving an X-ray image of said object, the rotary member having an opening in a center of rotation in which the object can be inserted and moved;
X-ray image forming means for forming a three-dimensional X-ray image of said object from an X-ray image taken by rotating said radiographic system around the object; and
placing means for placing said object and optionally setting an angle between a rotation center axis of said radiographic system and a direction of a longitudinal axis of the object:

2. An X-ray apparatus according to claim 1, wherein said placing means includes revolving means for revolving the object around an X-ray irradiation field center axis perpendicular to a floor on which said radiographic system is installed.

3. An X-ray apparatus according to claim 2, wherein said revolving means includes:
arc orbits disposed on the floor on which said placing means is installed; and
means disposed on said placing means for revolving along said orbits.

4. An X-ray apparatus according to claim 3, wherein said revolving means includes the arc orbits which are disposed in such a manner that a center axis of said arc orbits passes through an isocenter of said radiographic system, the isocenter being perpendicular to the floor.

5. An X-ray apparatus according to claim 2, wherein said revolving means includes:
a rotary shaft fixed to the floor at a position corresponding to the isocenter of said radiographic system, the isocenter being perpendicular to the floor;
a bearing mounted on said placing means and rotating around said rotary shaft; and
roller means mounted on a floor side of said placing means for revolving said placing means around said rotary shaft.

6. An X-ray apparatus according to any one of claims 1 to 5, wherein the rotary member includes:
a cylindrical support member having a rotation center corresponding to a rotation center of said radiographic system;
a first support member extending from said cylindrical support member and having said X-ray source on one end thereof; and
a second support member extending from said cylindrical support member and having said image receiving means at one end thereof.

7. An X-ray apparatus comprising:
a radiographic system for rotatably moving an X-ray source and an X-ray detector around an object;
a table device for horizontally revolving the object around an X-ray irradiation center axis perpendicular to a floor on which said radiographic system is installed; and
image processing means for forming a three-dimensional X-ray image of said object from an X-ray image taken at an optional angle to a longitudinal axis of said object.

8. An X-ray apparatus according to claim 6, wherein said table device includes revolving means for horizontally revolving said object around said X-ray irradiation field center axis.

9. An X-ray apparatus comprising:
an X-ray source for irradiating X-rays to an object;
an X-ray detector disposed facing said X-ray source across the object;
support means for supporting said X-ray source and said X-ray detector;
a rotary member for rotating said X-ray source and said X-ray detector together with said support means;
a bed for placing the object, said bed being movable along a longitudinal axis of the object; and
a guide member for guiding said bed to allow imaging at a desired angle to the rotation center axis of said rotary member.
